(19) United States
(12) Patent Application Publication
(10) Pub. No.: US 2026/0140419 A1
(43) Pub. Date: May 21, 2026

(54) RF TRANSMISSIVE ELECTRODES

(71) Applicant: Lawrence Livermore National Security, LLC, Livermore, CA (US)

(72) Inventors: Tyler FEARS, Pleasanton, CA (US); Ryan Alan Goldhahn, Livermore, CA (US); Tom Nakotte, Livermore, CA (US); Anna Hiszpanski, Pleasanton, CA (US)

(21) Appl. No.: 18/955,414

(22) Filed: Nov. 21, 2024

(51) Int. Cl. G02F 1/155; G02F 1/1516; G02F 1/153

(52) U.S. Cl. CPC G02F 1/155; G02F 1/15165; G02F 1/1533; G02F 2001/1536; G02F 2001/1552

(57) ABSTRACT

The present disclosure relates to an optically transmissive window apparatus. The window may make use of a non-electrically conductive substrate and a transparent conductive oxide (TCO) material layer disposed on the non-electrically conductive substrate, which is transmissive to a selected wavelength or range of wavelengths. An electrically conductive grating-like structure is disposed on or formed on the TCO material layer. The electrically conductive grating-like structure has a plurality of parallel metallic traces spaced apart by a selected spacing distance and works to dramatically reduce the RF reflectivity of the TCO material layer without impairing the electrochemical operation of the TCO material layer.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to optically transmissive electrodes, and more particularly to an optically transmissive electrode which is also highly RF transmissive.

### BACKGROUND

The statements in this section merely provide background information related to the present disclosure and may not constitute prior art.

Transparent conductive oxides (“TCO”) provide a continuous electrically conductive surface but have a comparatively low electrical conductivity that can result in significant voltage drops in large components. This can be overcome by adding conductive busbars (e.g., metal lines). The electrically conductive busbars provide a long-range, high conductivity pathway from the external electrical contact to the positions in the center of an electrochemically active window, after which the TCO provides continuous conductivity over a short range. This reduces the amount of the low-conductivity TCO in the conductive pathway.

Typical devices using high-performance TCOs require busbars to achieve desirable performance in devices over a couple centimeters. Such TCOs have sufficient electronic conductivity to effectively reflect RF radiation. By reducing the conductivity from a typical 10 ohm/sq to 300 ohm/sq, these TCO films go from >99.9% reflectivity to ˜15% reflectivity in the X band. However, such low sheet resistances make them unsuitable for large electrochemical windows. Metal meshes have high conductivity but provide a limited electrochemically active surface. Finely spaced metal meshes can provide a uniform electric field analogous to a flat metal plate, but they lose RF transparency as they approach the wavelength of incoming electromagnetic radiation.

Common metal meshes are square or hexagonal arrays of wires and effectively block all EM radiation above a certain wavelength. An array of parallel wires would, however, function as a polarizer, thus blocking radiation above a certain wavelength with polarization parallel to the wires and passing all other radiation. However, such a parallel array of wires cannot function as a freestanding mesh.

Accordingly, there is a need for an electrode construction which provides the electrode with excellent optically transmissive performance, while having significantly reduced RF reflectivity in a specified band or bands.

### SUMMARY

This section provides a general summary of the disclosure, and is not a comprehensive disclosure of its full scope or all of its features.

In one aspect the present disclosure relates to an optically transmissive window apparatus. The apparatus may comprise a non-electrically conductive substrate and a transparent conductive oxide (TCO) material layer which is transparent to a selected wavelength or range of wavelengths, disposed on the non-electrically conductive substrate. The apparatus may also comprise an electrically conductive grating-like structure having a plurality of parallel metallic traces spaced apart by a selected spacing distance.

In another aspect the present disclosure relates to a reversibly tinting window apparatus. The apparatus may comprise a first substrate material layer forming a working electrode, and a transparent conductive oxide (TCO) material layer. The TCO material layer is disposed on the first substrate material layer. The apparatus also includes a deposition catalyst layer disposed on the TCO material layer, and an ionic liquid electrolyte layer contained against or adjacent to the deposition catalyst layer. The apparatus further includes a second metallic grating-like structure having a plurality of parallel spaced apart traces and being disposed on or adjacent to the ionic liquid electrolyte layer. The apparatus further includes a second substrate material layer forming a counter electrode and disposed over the second metallic grating-like structure. A magnitude of tinting of the apparatus is controlled at least in part by a DC voltage applied across the working electrode and the counter electrode.

In still another aspect the present disclosure relates to a method for forming an optically transmissive window. The method may comprise providing a non-electrically conductive substrate, forming or disposing a transparent conductive oxide (TCO) material layer, which is transmissive at a selected wavelength or range of wavelengths, on the non-electrically conductive substrate, and forming or disposing an electrically conductive grating-like structure on the TCO material layer. The TCO material layer includes a plurality of parallel metallic traces spaced apart by a selected spacing distance.

In still another aspect the present disclosure relates to a method for forming a reversibly tinting window. The method may comprise providing a first substrate material layer forming a working electrode, and disposing or forming a transparent conductive oxide (TCO) material layer on the first substrate material layer. The method may further include disposing a deposition catalyst layer on or adjacent to the TCO material layer, and disposing or forming an ionic liquid electrolyte layer on the metallic nanoparticle layer. The method may further include forming or disposing a second metallic grating-like structure having a plurality of parallel spaced apart traces on the ionic liquid electrolyte layer, and disposing for forming a second substrate material layer, which forms a counter electrode, over the second metallic grating-like structure. A magnitude of tinting of the apparatus is controlled by a DC voltage applied across the working electrode and the counter electrode.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a perspective exploded view of an optically transmissive window in accordance with one embodiment of the present disclosure;

FIG. 2a is a plan view of an ITO material layer used to construct the window of FIG. 1 with one example of representative dimensions thereof;

FIG. 2b is a plan view of the metallic, electrically conductive grating-like structure shown in FIG. 1 but without the traces shown, to better illustrate one example of representative dimensions of the component;

FIG. 2c is a plan view of the insulating layer of the window shown in FIG. 1 with one example of representative dimensions thereof;

FIG. 3a a plan view of one example of just the metallic, electrically conductive grating-like structure with one example of representative dimensions of the structure;

FIG. 3b is a plan view of the structure of FIG. 3a disposed on an ITO material layer;

FIG. 4a is a plan view of a glass substrate showing one example of representative dimensions therefor;

FIG. 4b is a plan view of another example of a metallic, electrically conductive grating-like structure with one example of representative dimensions therefor;

FIG. 4c is a plan view of a low-conductivity ITO showing one example of representative dimensions therefor;

FIG. 5 shows how an effective resistance of an ITO material layer and a metallic grating-like structure may be calculated, and where the metallic grating-like structure is disposed below the ITO material layer;

FIG. 6 shows another embodiment of a window in accordance with the present disclosure which employs broken metallic traces that may reduce base reflectivity and remove polarization in the metal traces of a metallic, grating-like structure while maintaining sufficient long-range conductivity;

FIG. 7 shows another embodiment of a metallic grating-like structure having dissimilar hexagonal sections with varying metallic trace widths and spacings, and where the metallic grating-like structure is disposed below an ITO material layer; and

FIG. 8 shows one example of a reversibly tinting window with RF-transparent electrodes in accordance with the present disclosure.

### DETAILED DESCRIPTION

Example embodiments will now be described more fully with reference to the accompanying drawings.

The present disclosure relates to an optically transmissive electrode which also has the highly desirable feature of low RF reflectivity. In some implementations the embodiments and methods of the present disclosure achieve this through a parallel array of metallic wires which are deposited or otherwise disposed or formed on a desired substrate (e.g., glass). This produces an optically transmissive electrode with performance analogous to a standard metal mesh. In some embodiments, by combining a patterned stack of such optically transmissive electrodes in a beneficial geometry, RF reflectivity can be minimized while maximizing electrical conductivity for electrochemically active windows with high RF transmission.

In some embodiments the present disclosure forms optically transparent electrodes for electrochemically active window components, e.g., electrochromic windows. These electrochromic windows generally come in two varieties: transparent conductive oxide (TCO) films and metal meshes. By combining a finely spaced parallel array of metal traces with a low conductivity TCO, such as indium tin oxide (ITO)), the various embodiments described herein realize a large, electrochemically active window with low sheet resistance and dramatically increased RF transmission.

In some embodiments a parallel trace geometry is used to provide the RF transparency, as this geometry forms the most straightforward implementation of the present disclosure. However, the present disclosure is not limited to the use of only parallel metal traces, but rather other geometric designs may be used to meet the specific needs of a given application and to potentially further improve the RF performance of an electrochemically active window while still maintaining low sheet resistance.

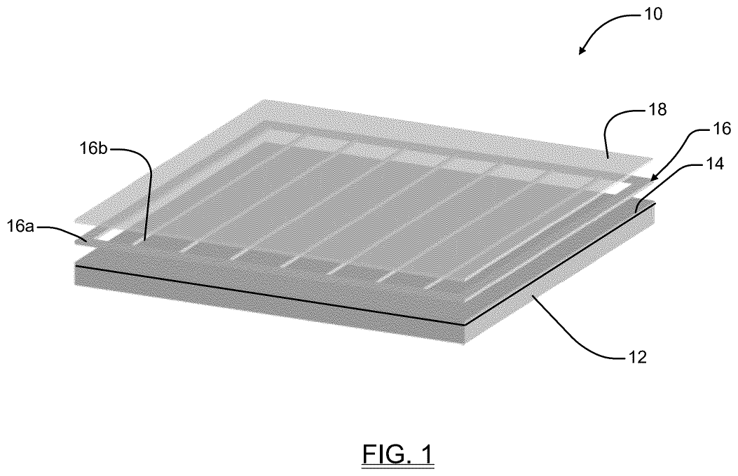

Referring to FIG. 1, there is shown one embodiment of an optically transmissive window 10 (hereinafter simply “window 10”) in accordance with the present disclosure. In this example the window 10 incorporates an electrically non-conductive substrate 12, for example glass or plastic. On a surface of the substrate 12 is a planar transparent conductive oxide (hereinafter simply “TCO”) material layer 14. In some embodiments the TCO material layer is formed by a TCO film. In some embodiments the TCO material layer 14 is an Indium transmissive oxide (“ITO”) material layer (e.g., in some embodiments a ITO film layer). Other possible TCO material layers that may be used are, without limitation, fluorine-doped tin oxide, and aluminum-doped zinc oxide. It will also be appreciated that conductive polymers might also be suitable for this layer. Such conductive polymers may include, without limitation, polyacetylenes, polythiophenes, polyanilines and polypyrroles. The TCO material layer 14 may vary in thickness but in most embodiments will preferably be between about 5 nm and 100 nm in thickness.

Over the TCO material layer 14, a metallic grating-like structure 16 is formed or otherwise disposed thereon. In some embodiments the busbars may instead be deposited under the TCO, and in some implementations this may actually be preferred to over the TCO in some circumstances, but is likely more difficult to manufacture. FIGS. 3, 4, 5, 6, and 7, to be discussed in the following paragraphs, all show metal traces below the TCO layer. The metallic grating-like structure 16 functions similar to a polarizer to dramatically reduce the RF reflectivity of the TCO material layer 14. The metallic grating-like structure 16 may be formed from gold, platinum or any other highly electrically conductive material, for example and without limitation, copper or aluminum. The metallic grating-like structure 16 includes a peripheral edge portion 16a which forms a bus to which other external electrically conductive elements (e.g., traces or wires) can be secured, and a plurality of parallel traces 16b. An insulating material film or layer 18 may then be disposed over the metallic grating-like structure 18.

The metallic-grating like structure 16 may deposited on the TCO film 14, in some cases, for example and without limitation, by physical vapor deposition, ink jetting and direct ink writing. The insulating film or layer 18 may in some embodiments be secured to the peripheral edge portion 16a and to upper surfaces of the parallel traces 16b by an appropriate adhesive or sealant, e.g., a chemically resistant epoxy or silicone.

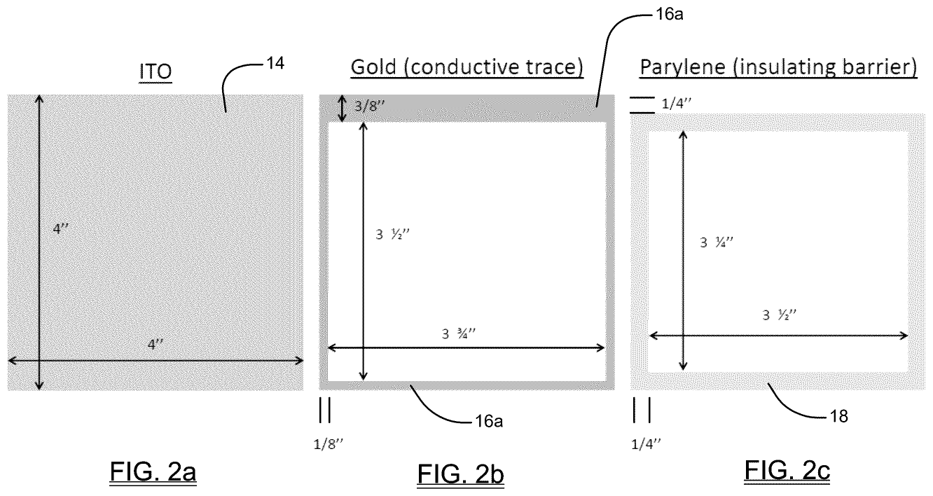

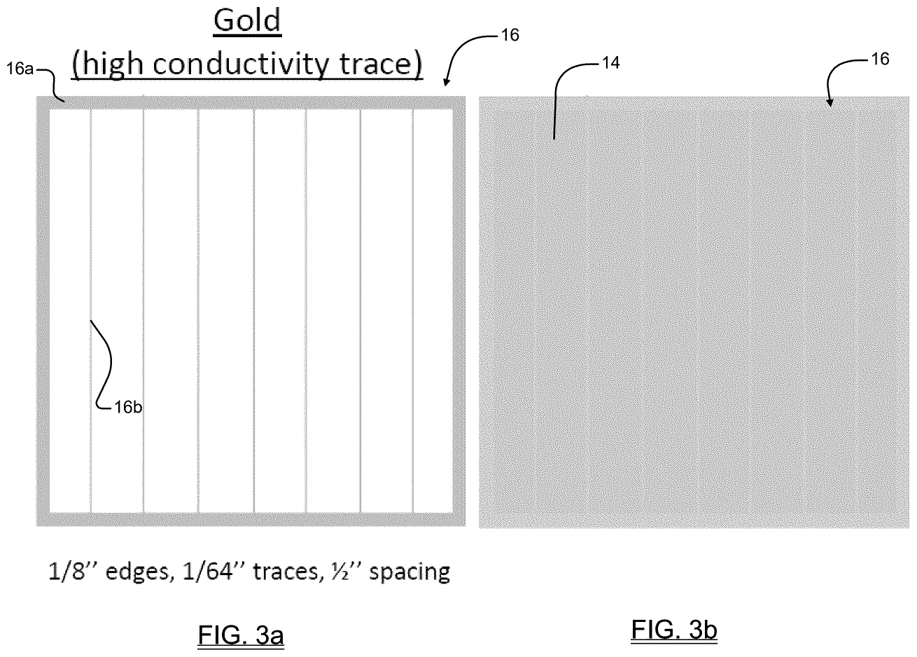

FIGS. 2a, 2b and 2c show one example of various dimensions that may be adhered to when starting with a 4 inch×4 inch (101.6 mm×101.6 mm) dimensioned substrate 12. The perimeter portion 16a of the metallic grating-like structure 16 (the parallel traces 16b having been omitted in FIG. 2b to better enable illustrating various dimensions) may be slightly larger along one side, for example 0.375 inch (9.53 mm) than the opposite side, which in this example is about 0.125 inch (3.175 mm). This is to better enable attachment of external conductors to the window 10. It is helpful to contact the metal traces directly, but is not necessary. The wide bands that form the perimeter portions 16a minimize deleterious effects of defects during metal film deposition. In this example the insulating film 18 forms a generally square shape with all sides being about 0.25″ (6.35 mm). It will be noted that the overall height (e.g., 3.25″; 82.55 mm) of the insulating film 18 in this example is slightly less than the overall width (e.g., 3.50″; 88.9 mm), which leaves a portion of the perimeter portion 16a exposed to enable easier attachment of external conductors to the window 10.

Referring briefly to FIG. 3, the metallic grating-like structure 16 is shown in isolation to better illustrate its various elements. In this example the width of the parallel traces 16b are about 1/64″ (i.e., 0.015625″ or 0.40 mm) in width. This dimension may vary significantly, but in most embodiments the width of the parallel traces 16b are expected to be between about 25 μm-500 μm. The thickness (or depth) of the parallel traces 16b in some embodiments may be 100 nm-10 μm, however this range may vary significantly depending on the deposition method used. The spacing between adjacent ones of the parallel traces 16b may also vary considerably depending on the wavelength of the RF signal that one wishes to be able to pass through the metallic grating-like structure 16, but in some embodiments may be, for example and without limitation, between about 500 um-5 mm, and in this specific example the spacing is 0.5″ (12.7 mm). It will be appreciated that the metallic, grating-like structure 16 has been illustrated in FIG. 3 without the enlarged perimeter portions 16a. The enlarged perimeter portions 16a, which effectively form busbar portions, in practice will have dimensions which are a parameter to be optimized.

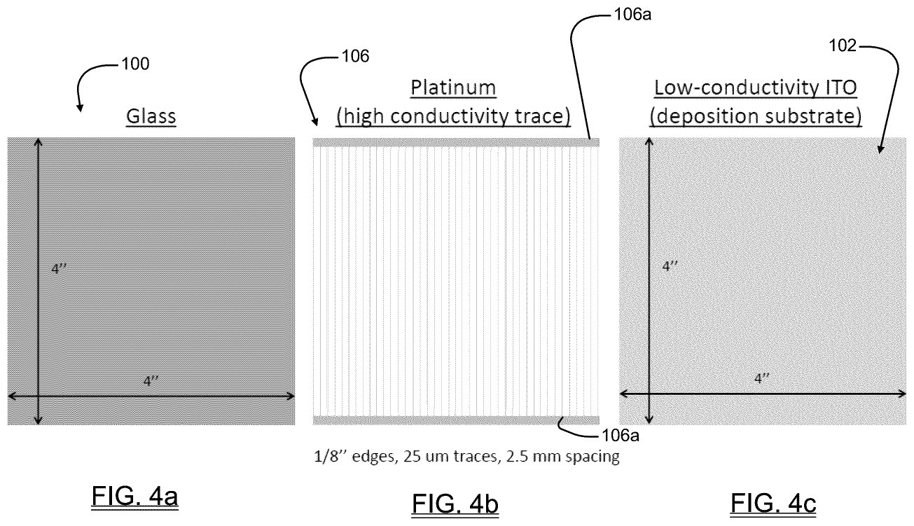

FIGS. 4a-4c show a glass substrate 102, a TCO film 104 and a metallic grating-like structure 106 in accordance with another embodiment of the present disclosure. In this example the TCO film 102 and the metallic grating-like structure 106 have the same outer dimensions as described in connection with TCO film 14 and metallic grating-like structure 16, but the metallic grating-like structure 106 has two outer perimeter portions 106 that are the same width (i.e., 0.125″; 3.175 mm), with high conductivity platinum traces 106b that are 25 μm in width and separated by a 2.5 mm spacing.

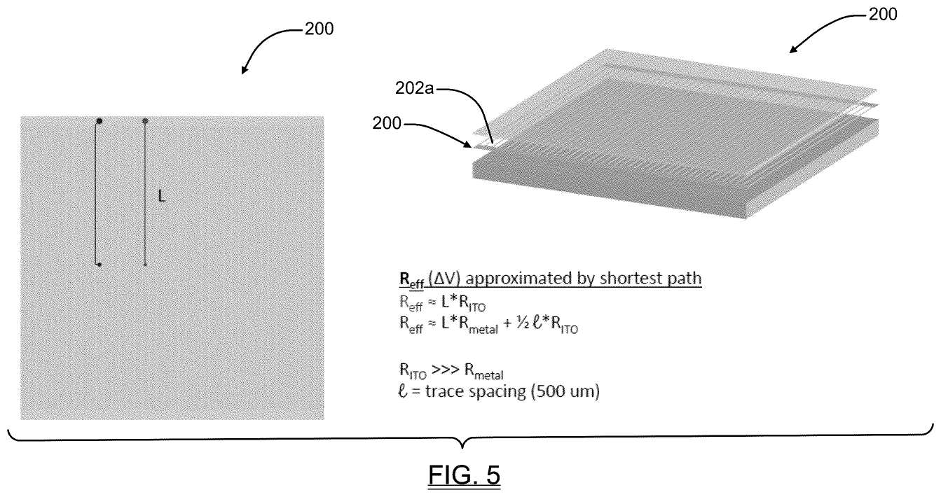

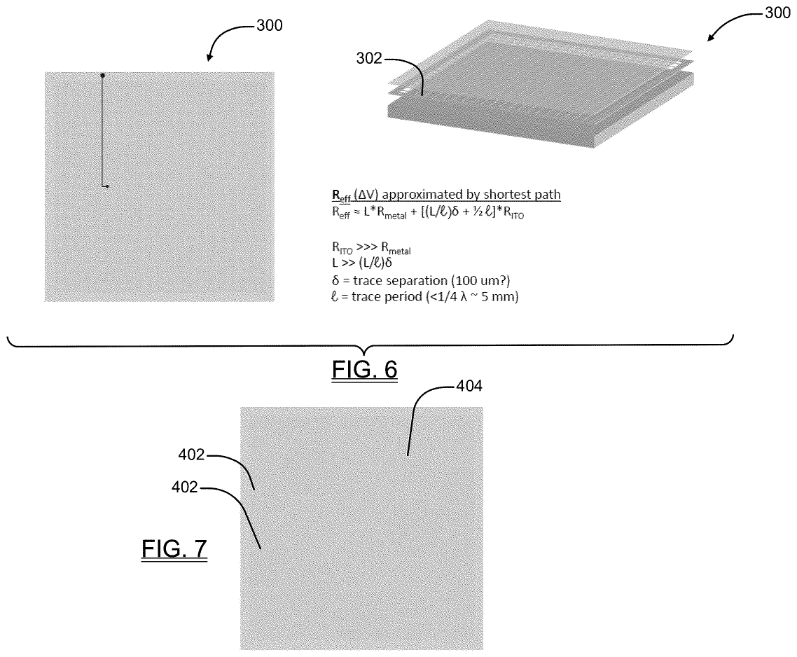

FIG. 5 shows how a resistance of an optically transmissive window 200 is determined. In this example the TCO is an ITO film and the width of and spacing between metallic traces 202a of a metallic, grating-like structure 202 is 25 μm and 500 μm, respectively. FIG. 6 shows another embodiment 300 of an optically transmissive window in accordance with the present disclosure where a spacing of metallic traces 302 are ¼λ, or 5 mm, the spacing between adjacent traces 202a is 100 μm, and how the effective resistance of the window 200 is qualitatively estimated. This embodiment demonstrates the use of broken traces that may reduce base reflectivity and remove polarization in the metal traces 202a of the metallic, grating-like structure 200 while maintaining sufficient long-range conductivity. The equations shown in FIG. 5 represent one highly approximate means to be used for design purposes to demonstrate and help designers understand how various window designs might trade off conductivity with geometric parameters.

FIG. 7 shows still another embodiment 400 of an optically transmissive window which makes use of an irregular, hexagonal tiling pattern of hexagonal sections 404 having metallic traces 402. This embodiment eliminates net polarization in transmitted and reflected signals when averaged over the entire field of view.

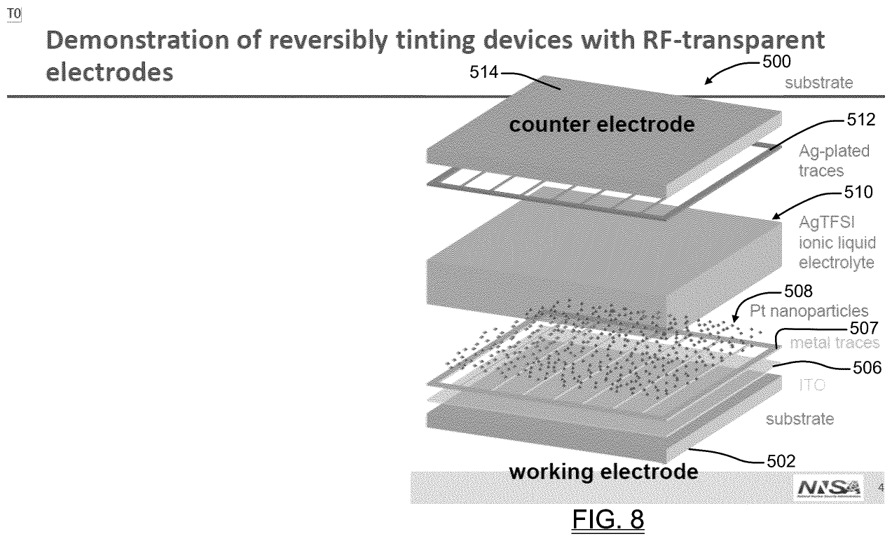

FIG. 8 shows another embodiment 500 of an optically transmissive window in accordance with the present disclosure, which in this example is reversibly tinting. By reversibly tinting it is meant that the degree of tint can be closely controlled. This is accomplished through a construction that uses a working electrode 502 with glass as the substrate, an ITO film 504, a first metallic layer grating structure 506 forming a plurality of conductive, parallel traces, a metallic, grating-like structure 507, and a quantity of Pt nanoparticles 508 forming a deposition catalyst layer. These components essentially form the working electrode portion of the window 500. A silver bis(trifluorosulfonyl)imide (AgTfSl) ionic liquid electrolyte layer 510, a grating structure 512 comprised of an Ag-plating forming parallel conductive traces 512, and a glass substrate form a counter electrode 514. In some embodiments the parallel conductive traces 512 forming the grating here is preferably relatively thick, for example and without limitation, ˜100 um silver (Ag) layer on top of a carbon layer. The silver participates in the electrochemical reaction, while the carbon (or other inert metal) maintains the conductive path if all the silver is consumed in a small section during operation, forming a defect.). It will also be appreciated that the ionic liquid electrolyte layer 510 in this example is encapsulated by a component not shown in the FIG. 9, but which seals the whole window cell 500, and places the layer 510 against or closely adjacent to the structures 508 and 512.

The metallic layer grating structure 508 may also be formed on an upper surface of the ITO film 506 or under the ITO film on an upper surface of the working electrode 504. An external DC voltage subsystem (not shown) may be used to apply a DC voltage across the working electrode 502 and the counterelectrode 516, wherein the total charge (current times time) of the applied DC voltage controls a degree of tint of the window.

In actual testing, the electrodes described herein operated as polarizers, showing near zero transmission in one orientation and transmission indistinguishable from the base electrode components in the orthogonal direction. Conductivity measurements showed a marked qualitative increase in conductivity when traces are applied on top of both 10 ohm/sq and 300 ohm/sq ITO.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An optically transmissive window apparatus comprising:
a non-electrically conductive substrate;
a transparent conductive oxide (TCO) material layer which is transparent to a selected wavelength or range of wavelengths, disposed on the non-electrically conductive substrate; and
an electrically conductive grating-like structure having a plurality of parallel metallic traces spaced apart by a selected spacing distance.

2. The apparatus of claim 1, wherein the TCO material layer comprises an Indium tin oxide (ITO) material layer.

3. The apparatus of claim 1, wherein the plurality of parallel metallic traces are uniform in width, with a width of each one of the plurality of parallel metal traces being between 25 μm and 500 μm.

4. The apparatus of claim 1, wherein each one of the plurality of parallel metallic traces has a thickness of between 10 nm and 10 μm.

5. The apparatus of claim 1, wherein the TCO conductive material layer comprises at least one of:
fluorine-doped tin oxide;
aluminum-doped zinc oxide;
polyacetylenes;
polythiophenes;
polyanilines; and
polypyrroles.

6. The apparatus of claim 1, wherein the plurality of parallel metallic traces are comprised of at least one of:
gold;
platinum;
copper; or
aluminum.

7. The apparatus of claim 1, further comprising an insulating barrier formed or placed on the TCO material layer.

8. The apparatus of claim 7, wherein the insulating barrier comprises a parylene material layer.

9. The apparatus of claim 1, wherein the electrically non-conductive substrate is comprised of at least one of glass or plastic.

10. A reversibly tinting window apparatus comprising:
a first substrate material layer forming a working electrode;
a transparent conductive oxide (TCO) material layer disposed on the first substrate material layer;
a deposition catalyst layer disposed on the TCO material layer;
an ionic liquid electrolyte layer contained against or adjacent to the deposition catalyst layer;
a second metallic grating-like structure having a plurality of parallel spaced apart traces and being disposed on or adjacent to the ionic liquid electrolyte layer; and
a second substrate material layer forming a counter electrode and disposed over the second metallic grating-like structure; and
wherein a magnitude of tinting of the apparatus is controlled at least in part by a DC voltage applied across the working electrode and the counter electrode.

11. The apparatus of claim 10, wherein the ionic liquid electrolyte layer is formed using a silver-based organic salt.

12. The apparatus of claim 10, wherein the deposition catalyst layer is comprised of at least one of nanoparticles formed from platinum.

13. The apparatus of claim 10, wherein the first metallic grating-like structure is formed from at least one of gold, platinum, copper or aluminum.

14. The apparatus of claim 10, wherein the second metallic grating-like structure is formed from at least one of gold, platinum, copper or aluminum.

15. The apparatus of claim 10, wherein the TCO layer is formed from indium tin oxide (ITO).

16. A method for forming an optically transmissive window, the method comprising:
providing a non-electrically conductive substrate;
forming or disposing a transparent conductive oxide (TCO) material layer, which is transmissive at a selected wavelength or range of wavelengths, on the non-electrically conductive substrate; and
forming or disposing an electrically conductive grating-like structure on the TCO material layer such that the TCO material layer includes a plurality of parallel metallic traces spaced apart by a selected spacing distance.

17. The method of claim 16, wherein forming or disposing a TCO material layer on the non-electrically conductive substrate comprises forming an Indium conductive oxide (ICO) material layer on the non-electrically conductive substrate.

18. The method of claim 16, wherein forming or disposing an electrically conductive grating-like structure comprises forming an electrically conductive grating-like structure from at least one of gold, platinum, copper or aluminum.

19. A method for forming a reversibly tinting window, the method comprising:
providing a first substrate material layer forming a working electrode;
disposing or forming a transparent conductive oxide (TCO) material layer on the first substrate material layer;
disposing a deposition catalyst layer on or adjacent to the TCO material layer;
disposing or forming an ionic liquid electrolyte layer on the metallic nanoparticle layer;
forming or disposing a second metallic grating-like structure having a plurality of parallel spaced apart traces on the ionic liquid electrolyte layer; and
disposing for forming a second substrate material layer, which forms a counter electrode, over the second metallic grating-like structure; and
wherein a magnitude of tinting of the apparatus is controlled by a DC voltage applied across the working electrode and the counter electrode.
